(19) United States
(12) Patent Application Publication
(10) Pub. No.: US 2003/0231864 A1
(43) Pub. Date: Dec. 18, 2003

(54) Digital broadcast receiver, remote controller, and regenerating method

(76) Inventor: Tatsuya Wakahara, Tokyo (JP)

Correspondence Address: William S. Frommer, Esq., FROMMER LAWRENCE & HAUG LLP, 745 Fifth Avenue, New York, NY, 10151, US

(21) Appl. No.: 10/413,871

(22) Filed: Apr. 15, 2003

(30) Foreign Application Priority Data
Apr. 16, 2002 (JP) 2002-112876

(51) Int. Cl. H04N 5/91

(52) U.S. Cl. 386/68; 386/52

(57) ABSTRACT

The invention aims to make it possible to easily reproduce a content, which is recorded in a storage medium, on a digital broadcast receiver. A receiving unit receives a signal sent from a remote controller. An icon associated with an instruction a user has entered is selected from among icons saved in an object save area. The icon is superposed on a video signal representing the content recorded in the storage medium, and displayed at a predetermined position on a display device for a predetermined time.

### BACKGROUND OF THE INVENTION

1. Field of the Invention

The present invention relates to a digital broadcast receiver that receives contents, or more particularly, to a digital broadcast receiver including a storage medium in which the contents are recorded.

2. Description of the Related Art

In recent years, digital broadcasting-satellite services have rapidly prevailed owing to the popularity of multiple channels and high image quality.

Some models of digital televisions (DTVs) or set top boxes (STBs), which can receive broadcasting-satellite services, include a digital interface that makes it possible to record digital broadcast as it is; such as, an i.LINK interface (i.LINK is a registered trademark of Sony Corp.) or an IEEE1394-conformable interface. Digital broadcasting enables recording in digital storage devices including a D-VHS video recorder (D-VHS is a registered trademark of Victor Company of Japan, Ltd.) and a hard disk video recorder (HDR) via the digital interface.

On the other hand, digital broadcast recorded in a digital storage device can be transferred to a digital TV or a set top box (STB) via a digital interface, and then reproduced.

A description will be made of reproduction of contents recorded in a digital storage device connected to a digital TV. Incidentally, the same applies to reproduction of contents recorded in a digital storage device connected to an STB. A description concerning the STB will therefore be omitted.

In the past, a graphical user interface (GUI) provided by a digital TV has been used to operate a D-VHS video recorder or a hard disk video recorder connected to the digital TV via an i.LINK interface.

FIG. 7 shows an example of a control panel realized with a GUI displayed on a digital TV.

FIG. 8 shows an example of a Cursor/Determine key included in a remote controller that is an accessory of a conventional digital TV.

While a user is enjoying digital broadcasting, for example, the user presses a Reproduce via i.LINK button on the remote controller. A reproduction control panel 500 like the one shown in FIG. 7 is displayed as a GUI on the screen.

The user presses the Up, Down, Right, and Left arrow buttons of a Cursor/Determine key 600 like the one shown in FIG. 8 so as to move a cursor on the control panel shown in FIG. 7. The user then presses a Determine button with the cursor located at a desired position. Thus, the user can select reproducing equipment, instruct basic actions including reproduction, suspension, quick feed, stoppage, and quick reverse (rewind), or select a content from a list screen image and instruct a reproductive action.

However, as mentioned above, the control panel 500 like the one shown in FIG. 7 has to be displayed for reproduction. The control panel 500 becomes an obstacle to viewing of a reproduced screen image.

Moreover, when a user instructs a reproductive action or a basic action such as suspension, quick feed, stoppage, or quick reverse (rewind), the user must use the remote controller to move a cursor displayed on the screen, to position the cursor at a desired button, and to press the Determine button. The user will therefore find it a nuisance to operate the video recorder. For example, in order to instruct quick reverse so as to view an overlooked scene, the user must display the control panel 500, move the cursor to a Quick Reverse button, and keep pressing the Determine button until the overlooked scene appears. When the overlooked screen appears, the user has to release the Determine button.

### SUMMARY OF THE INVENTION

Accordingly, an object of the present invention is to provide a digital broadcast receiver permitting reproduction of contents recorded in a connected storage medium without intervention in reproduction of a screen image.

Another object of the present invention is to provide a remote controller that is an accessory of a digital broadcast receiver and that is easily handled in order to reproduce a content recorded in a storage medium connected to the digital broadcast receiver.

Still another object of the present invention is to provide a reproducing method making it possible to reproduce a content, which is recorded in a storage medium connected to a digital broadcast receiver, without intervention in reproduction of a screen image.

In order to attain the objects, one aspect of the present invention resides in a digital broadcast receiver which connects with a storage medium, in which contents are recorded, wherein the digital broadcast receiver consists mainly of: a receiving means for receiving a predetermined instruction, which is related to reproduction of a content recorded in the storage medium, from a user; and a display means for displaying an object associated with the instruction while superposing it on a video signal representing the content.

According to the above constitution, a simple object associated with a predetermined instruction relevant to reproduction is displayed without intervention in reproduction of a content.

Another aspect of the invention resides in a remote controller that is an accessory of a digital broadcast receiver to receive and present digital broadcast, wherein the controller includes a control key having buttons thereof associated with instructions that initiate change of the reproduced state of a content recorded in a storage medium connected to the digital broadcast receiver.

According to the above constitution, the reproduced state of a content is changed using the control key whose buttons are associated with the instructions that initiate change of the reproduced state.

Still another aspect of the invention resides in a reproducing method to be implemented in a digital broadcast receiver which connects with a storage medium, in which contents are recorded, wherein the method comprises the steps of: receiving a predetermined instruction, which is related to reproduction of a content recorded in the storage medium, from a user; displaying an object associated with the instruction while superposing it on a video signal representing the content.

According to the above method, a simple object associated with a predetermined instruction relevant to reproduction is displayed without intervention in reproduction of a content.

Other and further objects, features and advantages of the invention will appear more fully from the following description.

### BRIEF DESCRIPTION OF THE DRAWINGS

FIG. 1 shows the principle and configuration of a digital broadcast receiver in accordance with an embodiment of the present invention;

FIG. 2 shows the hardware configuration of a digital broadcast receiver in accordance with an example of the present invention;

FIG. 3 shows assignment of facilities to a Cursor/Determine key formed on a remote controller that is an accessory of the digital broadcast receiver;

FIG. 4 shows a state transition occurring during reproduction of a content;

FIG. 5 shows a state transition occurring during reproduction of a content;

FIG. 6 shows an example of an i.LINK setting screen image;

FIG. 7 shows a control panel displayed as a GUI on the screen of a digital TV; and

FIG. 8 shows an example of a Cursor/Determine key included in a remote controller that is an accessory of a conventional digital TV.

### DESCRIPTION OF THE PREFERRED EMBODIMENTS

Referring to the drawings, an embodiment of the present invention will be described below.

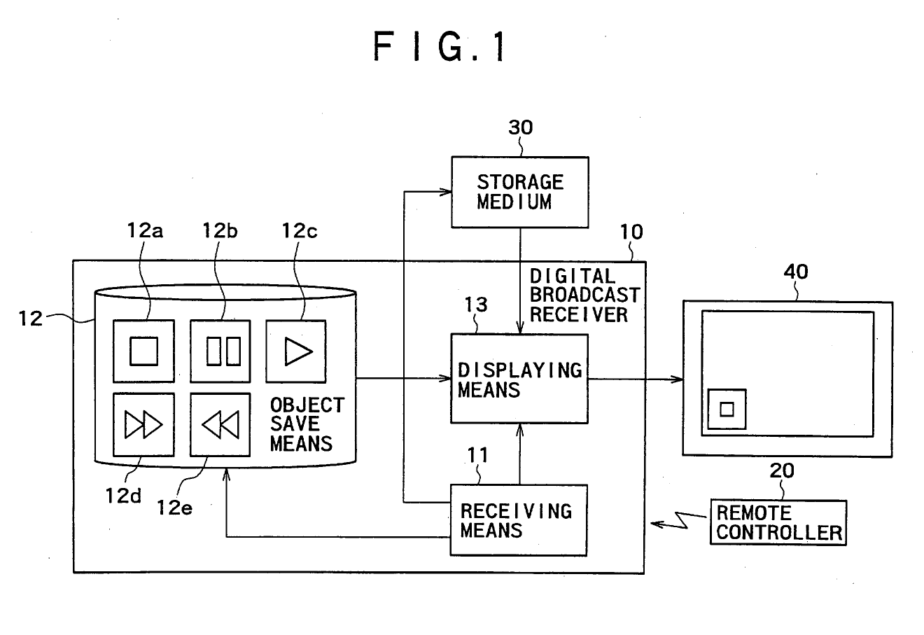

FIG. 1 shows the principle and configuration of a digital broadcast receiver in accordance with an embodiment of the present invention.

A digital broadcast receiver 10 consists mainly of: a receiving means 11 that receives a remote control signal originated responsively to user's handling of a remote controller 20; an object save means 12 in which a plurality of objects (hereinafter, icons) 12a, 12b, 12c, 12d, and 12e is saved; a displaying means 13 that retrieves a broadcast content from a storage medium 30, displays it on a display device 40, and also displays any of the icons 12a, 12b, 12c, 12d, and 12e saved in the object save means 12.

Herein, the icon 12a indicates stoppage, the icon 12b indicates suspension, the icon 12c indicates reproduction, the icon 12d indicates quick feed, and the icon 12e indicates quick reverse (rewind).

Noted is that a portion for receiving digital broadcast is not shown.

The remote controller 20 included in the present embodiment has a control key that is used to operate the storage medium 30 connected to the digital broadcast receiver 10. The control key has buttons thereof associated with instructions that initiate, for example, reproduction, stoppage, suspension, quick feed, and quick reverse respectively.

Actions to be performed in the digital broadcast receiver 10 will be described below.

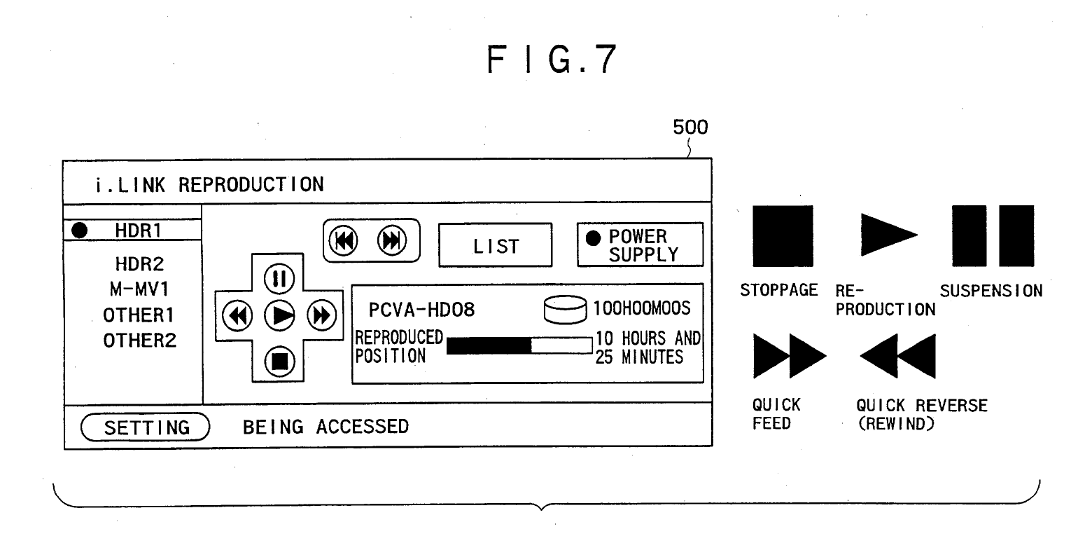

When a user wants to reproduce a content recorded in the storage medium 30 connected to the digital broadcast receiver 10, the user handles the remote controller 20. Accordingly, a reproduction control panel 500 like the one shown in FIG. 7 is displayed on the display device 40.

The user handles the remote controller 20 as he/she conventionally does so as to move a cursor on the screen. The user selects a content which is recorded in the storage medium 30 and which he/she wants to reproduce, and executes reproduction through the control panel 500. Consequently, the selected content is processed by the displaying means 13 and displayed on the display device 40. Furthermore, reproduction of the content starts. When the user handles the remote controller 20 so as to issue an instruction signifying that the control panel 500 displayed on the display device 40 should disappear, the displaying means 13 deletes the control panel 500 from the screen.

When a user wants to change the reproduced state of a content during reproduction of the content, the user handles the remote controller 20 so as to enter an instruction that initiates stoppage, suspension, quick feed, or quick reverse. Thereafter, the control panel 500 has had to be displayed again in the past. In contrast, in the digital broadcast receiver 10 in accordance with the present invention, the actions described below are performed.

First, the receiving means 11 receives a signal originated from the remote controller 20, and selects an icon associated with an instruction entered by a user from among the icons 12a, 12b, 12c, 12d, and 12e saved in the object save means 12. The receiving means 11 then transmits the selected icon to the displaying means 13. For example, when a user wants to stop reproduction, the user handles the remote controller 20. Based on a signal originated responsively to the handling, the icon 12a is selected from among the icons 12a, 12b, 12c, 12d, and 12e saved in the object save means 12, and transferred to the displaying means 13. The displaying means 13 stops reproduction of a content, and superposes the icon retrieved from the object save means 12 (for example, the icon 12a) on a video signal representing the content and being sent from the storage medium 30. The displaying means 13 then keeps transferring the resultant signal for a predetermined period so that the icon will be displayed at a predetermined position on the display device 40.

The same applies to suspension, quick feed, and quick reverse. For example, when suspension is instructed, the icon 12b is selected. When quick feed is instructed, the icon 12d is selected. When quick reverse is instructed, the icon 12e is selected. The selected icon is kept displayed for a predetermined period. When reproduction is instructed again, the icon 12c is kept displayed for the predetermined period.

In other words, when the reproduced state of a content makes a transition, a right icon is displayed for a predetermined period after the transition is made.

As mentioned above, when an action is instructed during reproduction, the control panel 500 is not displayed but a simple icon is displayed. Consequently, interference in reproduction of a screen image can be prevented.

Moreover, when an action is instructed during reproduction, it is unnecessary to move a cursor on the control panel 500. Reproduction is executed with a single press of a key on the remote controller 20. A user can therefore instruct quick feed, quick reverse, or any other action with simple handling. Since an icon is displayed during the action, the action can be performed reliably.

The foregoing description has been made with the one storage medium 30 shown connected to the digital broadcast receiver 10. Alternatively, a plurality of digital storage media may be connected using a hub or the like.

The way of displaying the icons 12a, 12b, 12c, 12d, and 12e and the number of icons which are described above are presented as mere examples.

Next, an example of the present invention will be detailed below.

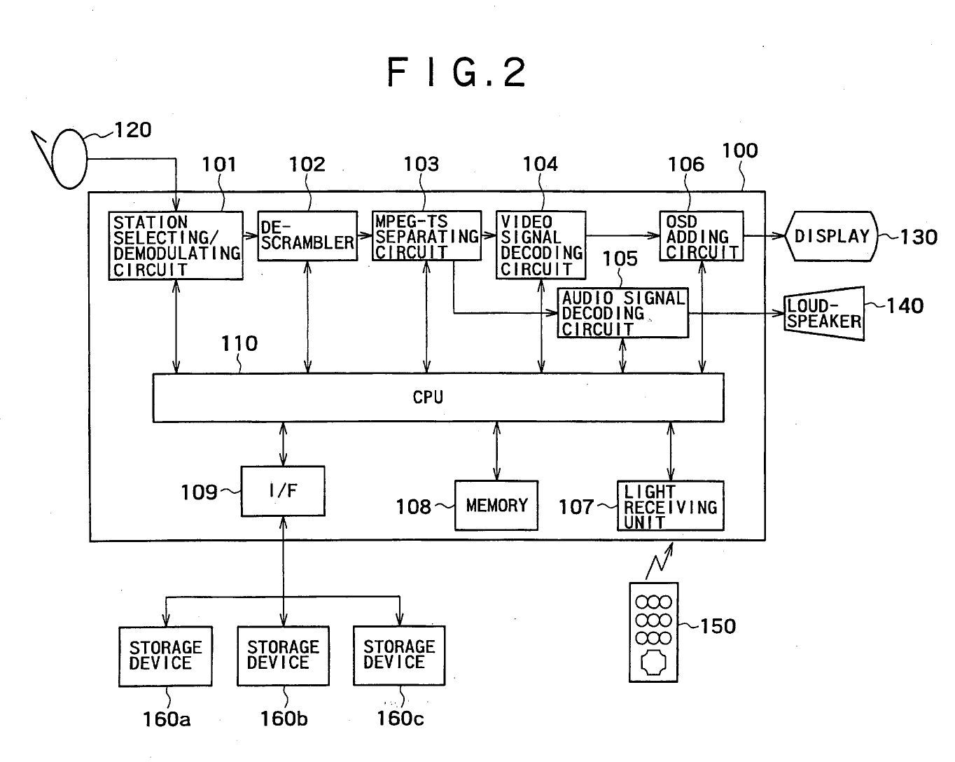

FIG. 2 shows the hardware configuration of a digital broadcast receiver in accordance with an example of the present invention.

A digital broadcast receiver 100 consists mainly of: a station selecting/demodulating circuit 101 that is connected to an antenna 120, selects a broadcasting station, or demodulates a signal; a de-scrambler 102 that unscrambles data; an MPEG (which stands for the moving picture experts group)-TS separating circuit 103 that separates an encoded video signal and audio signal, which are contained in a transport stream (TS) of received multiplexed digital broadcast signals, from each other; a video signal decoding circuit 104 that decodes the encoded video signal into an NTSC signal or the like; an audio signal decoding circuit 105 that decodes the encoded audio signal and transfers the resultant signal to a loudspeaker 140; an OSD (which stands for On-screen display) adding circuit 106 that adds a data-broadcasting screen image or a display signal to a video signal and transfers the resultant signal to a display 130; a light receiving unit 107 that receives an instruction which a user has entered using a remote controller 150; a memory 108 in which display data, an operating system (OS), and others are saved; an interface 109 that provides an interface for digital storage devices 160a, 160b, and 160c; and a CPU 110 that controls these components.

Herein, the interface 109 is a digital interface conformable to the IEEE1394 standard or an i.LINK digital interface.

Moreover, the digital storage devices 160a, 160b, and 160c are D-VHS recorders, hard disk recorders (HDR), or camcorders conformable to the MPEG recommendation.

Actions to be performed in the digital broadcast recorder 100 will be described below.

To begin with, actions to be performed when a user wants to enjoy a normal digital broadcasting-satellite service will be described below.

When a user selects a broadcasting station using the remote controller 150, the light receiving unit 107 receives a station selecting signal sent from the remote controller 150. The station selecting signal is also transferred to the station selecting/demodulating circuit 101 via the CPU 110. The station selecting/demodulating circuit 101 selects a broadcasting station according to the station selecting signal, receives image information, which has been modulated and transmitted in the form of a transport stream, through the antenna 120, and demodulates it. If the received information is pay broadcast data or any other encrypted data, the de-scrambler 102 unscrambles the data under the control of the CPU 110. The MPEG-TS separating circuit 103 de-multiplexes the transport stream. Since the separated video signal and audio signal have been encoded, the video signal decoding circuit 104 decodes the video signal and the audio signal decoding circuit 105 decodes the audio signal. When a data broadcasting service is received, the MPEG-TS separating circuit 103 separates a data broadcast signal and transfers it as a data broadcast screen image display signal to the OSD adding circuit 106 via the CPU 110. The video signal decoding circuit 104 adds the display signal to the video signal that has been decoded by the video signal decoding circuit 104, and transfers the resultant signal to the display 130. The decoded audio signal is distributed through the loudspeaker 140.

When a user wants to record a content to be broadcast, the user presses, for example, a Record button on the remote controller 150. Consequently, the content is recorded in any of the digital storage devices 160a, 160b, and 160c connected to the interface 109.

Next, a description will be made of a case where a recorded content is reproduced under the control of the digital broadcast receiver 100.

Hereinafter, a description will be made on the assumption that an i.LINK interface is adopted as the interface 109.

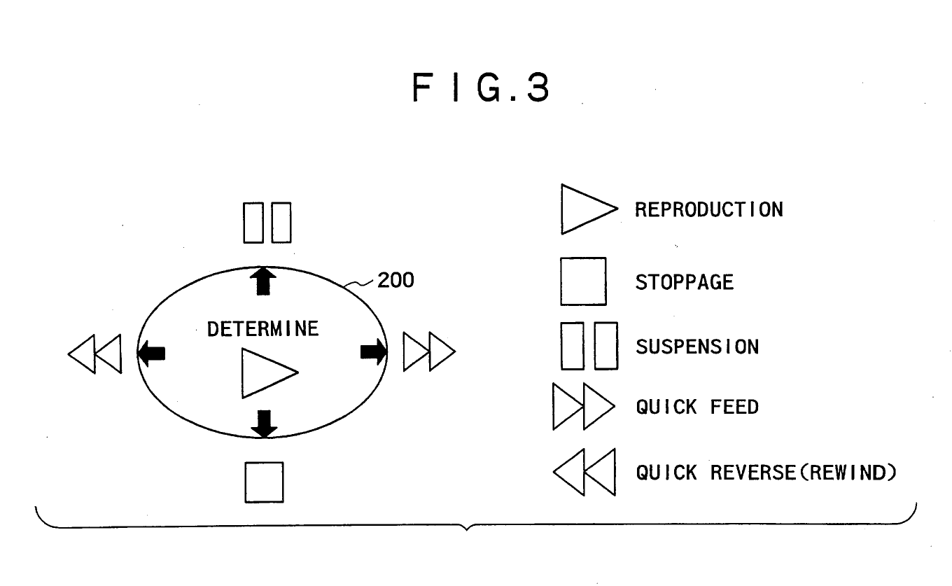

FIG. 3 shows assignment of facilities to a Cursor/Determine key on the remote controller that is an accessory of the digital broadcast receiver.

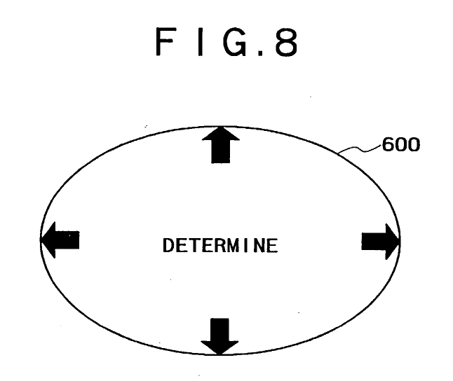

Similarly to the related art shown in FIG. 8, a Cursor/Determine key 200 has buttons of up, down, right, and left arrows.

In the present example of the present invention, facilities for suspension, stoppage, quick feed, and quick reverse are assigned to the buttons of the up, down, right, and left arrows of the Cursor/Determine key 200. The facility for reproduction is assigned to the central Determine button.

Actions described below are initiated using the remote controller 150 shown in FIG. 2.

For reproduction, the light receiving unit 107 included in the digital broadcast receiver 100 receives an instruction a user has entered using the remote controller 150. According to the instruction, a control signal or record data is transferred to or from any of the digital storage devices 160a, 160b, and 160c via the interface 109 (i.LINK) under the control of the CPU 110. Equipment from which data is reproduced is selected from among the digital storage devices 160a, 160b, and 160c. A recorded content is read under the control of the CPU 110. The video signal decoding circuit 104 and audio signal decoding circuit 105 decode the video and audio signals separated from each other, and transfer the resultant signals to the display 130 and loudspeaker 140 respectively. Furthermore, data required to display the control panel 500, message boxes 300a and 300b that will be described later, and icons 400a, 400b, 400c, 400d, and 400e is retrieved from the memory 108 under the control of the CPU 110. The OSD adding circuit 106 superposes the retrieved data on the decoded video signal representing the content. According to the resultant data, an image is displayed or deleted on or from the display 130.

Hereinafter, a description will be made of a method of reproducing a content that is implemented in the digital broadcast receiver 100.

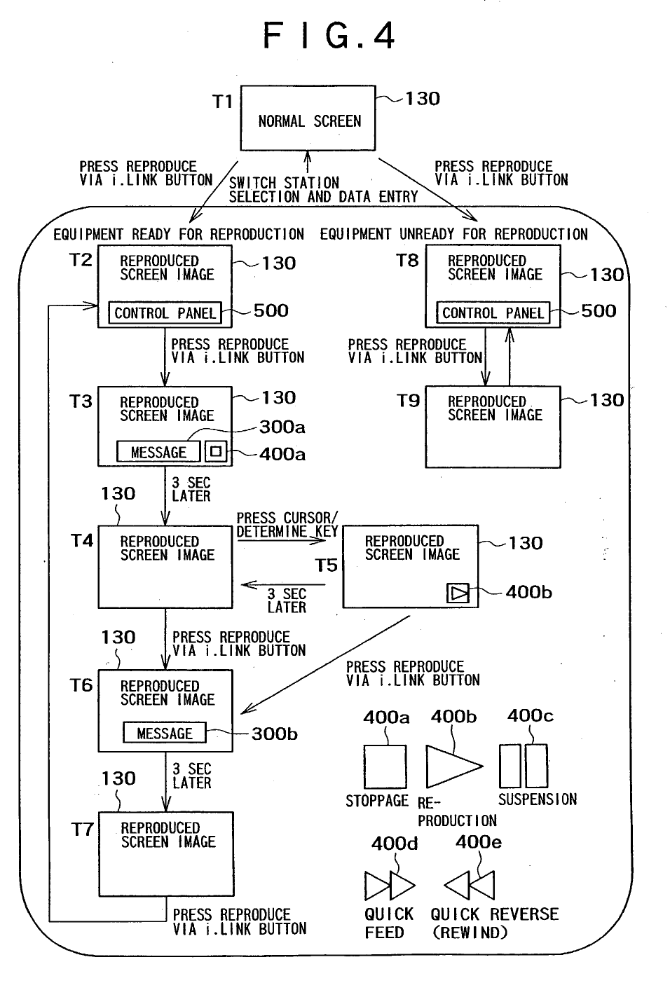

FIG. 4 shows a state transition occurring during reproduction of a content Referring to FIG. 4, T1 to T9 denote respective states.

T1: a state in which a normal screen image is displayed but a content is not reproduced from in a digital storage device connected via an i.LINK interface (hereinafter, from equipment connected via an i.LINK).

For example, a content that is a broadcast program being received is displayed on the display 130 as described previously. In this state, when a Reproduce via i.LINK button that is not shown and included in the remote controller 150 is pressed, if a previously selected one of the digital storage devices 160a, 160b, and 160c which is connected via an i.LINK interface is ready for reproduction, the state T1 is changed to state T2. If the previously selected storage device is unready for reproduction, the state T1 is changed to state T8.

T2: a state in which a content is reproduced from equipment connected via an i.LINK with a control panel displayed.

Herein, a control panel 500 for reproduction (to which the same reference numeral is assigned as that is to the conventional control panel 500 because they are identical to each other) is displayed on the display 130. Moreover, an image reproduced from equipment selected previously from among the digital storage devices 160a, 160b, and 160c is also displayed on the display 130. If the previously selected one of the digital storage devices 160a, 160b, and 160c is placed in stop mode, a black screen image appears.

In this state, equipment from which a user wants to reproduce data is selected from among the digital storage devices 160a, 160b, and 160c through the control panel 500 using the Cursor/Determine key 200 on the remote controller 150. A content the user wants to reproduce is selected, and a Reproduce button is pressed. The content is then reproduced on the display 130. In this state, the control panel 500 is still displayed on the display 130.

A description will be made on the assumption that the digital storage device 160a is selected. Incidentally, the same actions as described below will be performed even when the digital storage device 160b or 160c is selected.

When the Reproduce via i.LINK button that is not shown and formed on the remote controller 150 is pressed, the state T2 is changed to state T3.

T3: a state in which an icon indicating a reproduced state is displayed with the control panel deleted.

The control panel 500 for reproduction is deleted. Instead, any of the icons 400a, 400b, 400c, 400d, and 400e is displayed at a predetermined position according to the state of a content reproduced from the digital storage device 160a.

Herein, the icon 400a indicates stoppage, the icon 400b indicates reproduction, the icon 400c indicates suspension, the icon 400d indicates quick feed, and the icon 400e indicates quick reverse (rewind). In the state T3 shown in FIG. 4, since the digital storage device 160a is placed in stop mode, the icon 400a is displayed.

Moreover, the message box 300a may be displayed as shown in FIG. 4. A message saying “The equipment connected via an i.LINK can be operated using the Determine button and the cursor.” may be displayed. In this case, with a press of any of the Reproduce, Stoppage, Suspend, Quick Feed, and Quick Reverse buttons whose capabilities are assigned to the buttons of the Cursor/Determine key 200 on the remote controller 150 as shown in FIG. 3, the reproduced state of a content can be changed directly. With the elapse of a predetermined time (for example, three seconds), the state T3 is changed to step T4.

T4: a state in which the icon is deleted.

Any of the icons 400a, 400b, 400c, 400d, and 400e displayed is deleted for fear it may interfere in reproduction of a screen image. An i.LINK reproduction screen image is displayed on the screen, and a reproduced screen image of a content recorded in the digital storage device 160a is displayed. Herein, when an instruction such as stoppage or suspension is entered using the Cursor/Determine key 200 on the remote controller 150, a reproduced state different from the reproduced state of state T4 may be attained. In this case, the state T4 is changed to state T5. If the Reproduce via i.LINK button that is not shown is pressed, the state T4 is changed to state T6.

T5: a state in which any of the icons 400a, 400b, 400c, 400d, and 400e is displayed again.

Herein, any of the icons 400a, 400b, 400c, 400d, and 400e is displayed at the predetermined position on the display 130 again. FIG. 4 shows an example in which after reproduction is instructed using the Cursor/Determine key 200 on the remote controller 150 with the digital storage device placed in stop mode, the icon 400b indicating reproduction is displayed on the display 130.

With the elapse of a predetermined time (for example, three seconds) in the above state, the state T5 is changed to the state T4. If the Reproduce via i.LINK button that is not shown is pressed, the state T5 is changed to state T6.

T6: a state in which the Cursor/Determine key on the remote controller is used to move the cursor on the screen.

The Cursor/Determine key 200 is used to move the cursor on the display 130 as it conventionally is. For example, the Cursor/Determine key 200 is used to initiate bi-directional data-broadcasting communication. Furthermore, the message box 300b is displayed and a message saying “The equipment connected via an i.LINK is returned to the normal mode.” is displayed in order to call a user's attention. With the elapse of a predetermined time (for example, three seconds), the state T6 is changed to state T7.

T7: a state in which the message box is deleted.

The-message box 300b displayed in the state T6 is deleted. In this state, the normal Cursor/Determine key 200 is used to move the cursor normally. A screen image reproduced from the digital storage device 160a is displayed on the display 130. In order to instruct suspension or quick feed, the control panel 500 is displayed as it conventionally is, and the Cursor/Determine key 200 on the remote controller 150 is handled. In order to change the reproduced state of a content, the Reproduce via i.LINK button that is not shown is pressed. Consequently, the state T7 is changed to the state T2.

T8: a state in which the previously selected digital storage device connected via the i.LINK interface is equipment that is unready for reproduction.

If the Reproduce via i.LINK button that is not shown is pressed in the state T1, if the digital storage device 160a, 160b, or 160c connected via the i.LINK interface is equipment that is unready for reproduction, the control panel 500 is displayed as usual. However, a reproduced screen image is a black image. Herein, if the Reproduce via i.LINK button that is not shown is pressed, the state T8 is changed to state T9.

T9: a state in which the control panel displayed is deleted.

The control panel 500 is deleted from the reproduced screen image on the display 130. However, since the equipment is unready for reproduction, the reproduced screen image is black.

Moreover, if the remote controller 150 is handled in order to select a broadcasting station or switch input modes in any of the states T2 to T9, the state is changed to the state T1. A content is not reproduced from the equipment connected via an i.LINK but a received normally digitally broadcast content is displayed.

As mentioned above, the Reproduce via i.LINK button that is not shown is pressed in order to select whether the Cursor/Determine key 200 on the remote controller 150 is used to move the cursor as it conventionally is or to control reproduction of data from equipment connected via an i.LINK. This setting may be determined in advance through menu selection or the like in order to designate to which of the states a transition is made with a press of the Reproduce via i.LINK button that is not shown. A reproducing method to be implemented in the digital broadcast receiver 100 in this case will be described below.

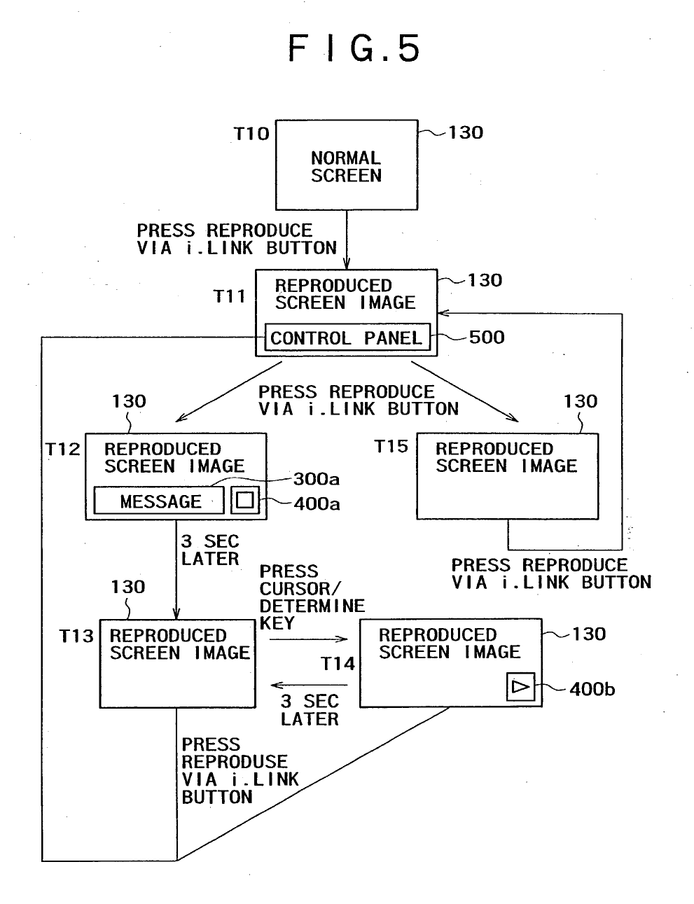

FIG. 5 shows a state transition occurring during reproduction of a content.

Herein, a description will be made in relation only to equipment that is ready for reproduction.

Moreover, reproduction of a content recorded in the digital storage device 160a will be described below. The same applies to reproduction of a content recorded in the digital storage device 160b or 160c. The description of the reproduction will therefore be omitted.

Referring to FIG. 5, T10 to T13 denote respective states.

T10: a state in which a normal screen image is displayed but a content is not reproduced from equipment connected via an i.LINK.

Herein, when the Reproduce via i.LINK button is pressed, the state T10 is changed to state T11.

T11: a state in which a content is reproduced from equipment connected via an i.LINK with the control panel displayed.

As shown in FIG. 5, the control panel 500 is displayed and a screen image reproduced from the digital storage device 160a is displayed. If the digital storage device 160a is in stop mode, a black image appears.

In the state T11, when the Reproduce via i.LINK button that is not shown is pressed, state T12 in which the Cursor/Determine key 200 on the remote controller 150 is used to reproduce a content recorded in the digital storage device 160a connected via an i.LINK interface or state T15 in which the Cursor/Determine key 200 is used to move the cursor as usual is selected according to the predetermined setting.

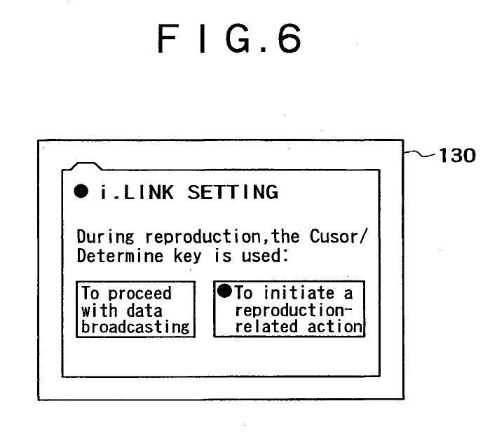

FIG. 6 shows an example of an i.LINK setting screen image.

For example, when the settings of the digital broadcast receiver 100 are determined, if connection via an i.LINK interface is designated, the i.LINK setting screen image appears on the display 130.

As illustrated, whether the Cursor/Determine key 200 is used to proceed with data broadcasting or to initiate a reproduction-related action during reproduction is selected.

At this time, when using the Cursor/Determine key 200 to initiate a reproduction-related action is selected, if the Reproduce via i.LINK button that is not shown is pressed in the state T11, the state is changed to state T12. When using Cursor/Determine key 200 to proceed with data broadcasting is selected, if the Reproduce via i.LINK button that is not shown is pressed in the state T11, the state is changed to state T15.

T12: a state in which the control panel is deleted and an icon indicating a reproduced state is displayed.

For example, a message saying “The equipment connected via an i.LINK can be operated using the Determine key and the cursor.” is displayed in the message box 300a. Thus, a user's attention is called. Furthermore, any of the icons 400a, 400b, 400c, 400d, and 400e shown in FIG. 4 is displayed based on the state of a content reproduced from the selected digital storage device 160a. After a certain time (for example, three seconds) elapses, the state T12 is changed to state T13.

T13: a state in which the icon is deleted.

Any of the icons 400a, 400b, 400c, 400d, and 400e displayed is deleted for fear it may interfere in reproduction of a screen image. The i.LINK reproduction screen image is displayed on the screen, and a screen image representing a content reproduced from the digital storage device 160a is displayed. At this time, if the Cursor/Determine key 200 on the remote-controller 150 is used to enter an instruction initiating stoppage or suspension, a reproduced state becomes different from the one of the state T13. Consequently, the state T13 is changed to state T14. If the Reproduce via i.LINK button is pressed, the state T13 is changed to the state T11.

T14: a state in which the icon is displayed again.

Herein, any of the icons 400a, 400b, 400c, 400d, and 400e is displayed at the predetermined position on the display 130 again. FIG. 5 shows an example of a screen image in which the icon 400b indicating reproduction is displayed after the Cursor/Determine key 200 on the remote controller 150 is used to instruct reproduction with the digital storage device placed in stop mode.

In this state, when a predetermined time (for example, three seconds) has elapsed, the state T14 is changed to state T13. If the Reproduce via i.LINK button is pressed, the state T14 is returned to the state T11.

T15: a state in which the control panel is deleted.

The control panel 500 being displayed in the state T11 is deleted. In this state, the Cursor/Determine key is used to move the cursor as usual. A screen image reproduced from the digital storage device 160a is displayed on the display 130. Herein, in order to instruct suspension or quick feed, the control panel 500 is displayed as it conventionally is, and the Cursor/Determine key 200 on the remote controller 150 is used. If the reproduced state must be changed, the Reproduce via i.LINK button is pressed again. The state is then changed to the state T11.

As mentioned above, when an action is instructed during reproduction, the control panel 500 is not displayed but a simple icon is displayed. Consequently, interference in reproduction of a screen image can be prevented.

Moreover, when an action is instructed during reproduction, the cursor need not be moved on the control panel 500 but the key on the remote control 150 is pressed once. Thus, reproduction is executed. A user can instruct quick feed, quick reverse, or any other action through simple handling. At this time, an icon associated with the instructed action is displayed. The action can therefore be performed reliably.

In the aforesaid example, the three digital storage devices 160a, 160b, and 160c are connected to the digital broadcast receiver 100. The number of digital storage devices to be connected to the digital broadcast receiver 100 is not limited to three.

Moreover, the number of icons 400a, 400b, 400c, 400d, and 400e and the way of displaying them are presented merely as examples.

As described so far, according to the present invention, when an action is instructed during reproduction of a content from a digital storage device connected to a digital broadcast receiver, a simple object is displayed. Consequently, interference in reproduction of a screen image can be prevented.

Moreover, an action relevant to reproduction can be easily initiated by merely pressing a button of a control key associated with the action and formed on a remote controller.

The foregoing invention has been described in terms of preferred embodiments. However, those skilled, in the art will recognize that many variations of such embodiments exist. Such variations are intended to be within the scope of the present invention and the appended claims.

What is claimed is:

1. A digital broadcast receiver which connects with a storage medium, in which contents are recorded, comprising:
a receiving means for receiving a predetermined instruction, which is related to reproduction of a content recorded in said storage medium, from a user; and
a displaying means for superposing an object, which is associated with the instruction, on a video signal representing the content.

2. A digital broadcast receiver according to claim 1, wherein the instruction initiates reproduction, stoppage, suspension, quick feed, or quick reverse.

3. A digital broadcast receiver according to claim 1, wherein said displaying means deletes the object after displaying it for a predetermined period.

4. A remote controller that is an accessory of a digital broadcast receiver for receiving and presenting digital broadcast, comprising:
a control key having buttons thereof associated with instructions that initiate change of the reproduced state of a content recorded in a storage medium connected to said digital broadcast receiver.

5. A remote controller according to claim 4, wherein the instructions initiate reproduction, stoppage, suspension, quick feed, and quick reverse respectively.

6. A reproducing method to be implemented in a digital broadcast receiver which connects with a storage medium, in which contents are recorded, comprising the steps of:
receiving a predetermined instruction, which is related to reproduction of a content recorded in said storage medium, from a user;
displaying an object associated with the instruction while superposing it on a video signal representing the content.

7. A reproducing method according to claim 6, wherein the instruction initiates reproduction, stoppage, suspension, quick feed, or quick reverse.

8. A reproducing method according to claim 6, wherein the object is deleted after being displayed for a predetermined period.
